(19) United States
(12) Patent Application Publication
(10) Pub. No.: US 2004/0145861 A1
(43) Pub. Date: Jul. 29, 2004

(54) Detection and display of status of container

(76) Inventor: Jen-Fu Chen, Feng Yuan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/351,688

(22) Filed: Jan. 27, 2003

(51) Int. Cl. G06F 1/16; G09G 5/00; G01K 1/00

(52) U.S. Cl. 361/681; 345/740; 345/859; 345/156; 374/100

(57) ABSTRACT

In an aspect, a system for recording and displaying the status of a container includes a recording assembly and a displaying assembly. The recording assembly includes a keypad via which data are entered and a transmitter for transmitting the data in a cable-free manner. The displaying assembly includes a receiver for receiving the data from the transmitter and a display for displaying the data. In another aspect, a system for detecting and displaying the status of a container includes a detecting assembly and a displaying assembly. The detecting assembly includes a probe extending into the container for detecting a factor of the status of the container and producing data representative of the factor and a transmitter for transmitting the signal in a cable-free manner. The displaying assembly includes a receiver for receiving the data from the transmitter and a display for displaying the data.

### BACKGROUND OF INVENTION

1. Field of Invention

The present invention relates to a system for detecting and displaying the status of a container.

2. Related Prior Art

Taiwanese Patent Publication No. 442638 discloses a refrigerator 10 equipped with a display 28 for displaying the temperature set for the interior thereof, the status of the interior thereof and the status of the operation thereof. A user has to move to the refrigerator 10 in order to read information provided by means of the display 28 since the display 28 is installed on the refrigerator 10. If a user uses several refrigerators 10 and wants to learn the information displayed by means of the displays 28 installed on the refrigerators 10, he or she must move to the refrigerators 10 one by one. This is inconvenient.

The present invention is therefore intended to obviate or at least alleviate the problems encountered in prior art.

### SUMMARY OF INVENTION

It is an objective of the present invention to provide a convenient system for recording and displaying the status of a container.

To this end, a system for recording and displaying the status of a container includes a recording assembly and a displaying assembly. The recording assembly includes a keypad via which data are entered and a transmitter for transmitting the data in a cable-free manner. The displaying assembly includes a receiver for receiving the data from the transmitter and a display for displaying the data.

It is another objective of the present invention to provide a convenient system for detecting and displaying the status of a container.

To this end, a system for detecting and displaying the status of a container includes a detecting assembly and a displaying assembly. The detecting assembly includes a probe extending into the container for detecting a factor of the status of the container and producing data representative of the factor and a transmitter for transmitting the signal in a cable-free manner. The displaying assembly includes a receiver for receiving the data from the transmitter and a display for displaying the data.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a perspective view of a system for detecting and displaying the status of a container according to a first embodiment of the present invention.

FIG. 2 is an exploded view of a detecting assembly of the recording, detecting and displaying system shown in FIG. 1.

FIG. 3 is a block diagram of the detecting assembly shown in FIG. 2.

FIG. 4 is a block diagram of a remote displaying assembly of the recording, detecting and displaying system shown in FIG. 1.

FIG. 5 is a perspective view of several containers each equipped with the recording, detecting and displaying system shown in FIG. 1.

FIG. 6 is a cross-sectional view of a system for detecting and displaying the status of a container according to a second embodiment of the present invention.

FIG. 7 is a perspective view of a system for detecting and displaying the status of a container according to a third embodiment of the present invention.

### DETAILED DESCRIPTION OF EMBODIMENTS

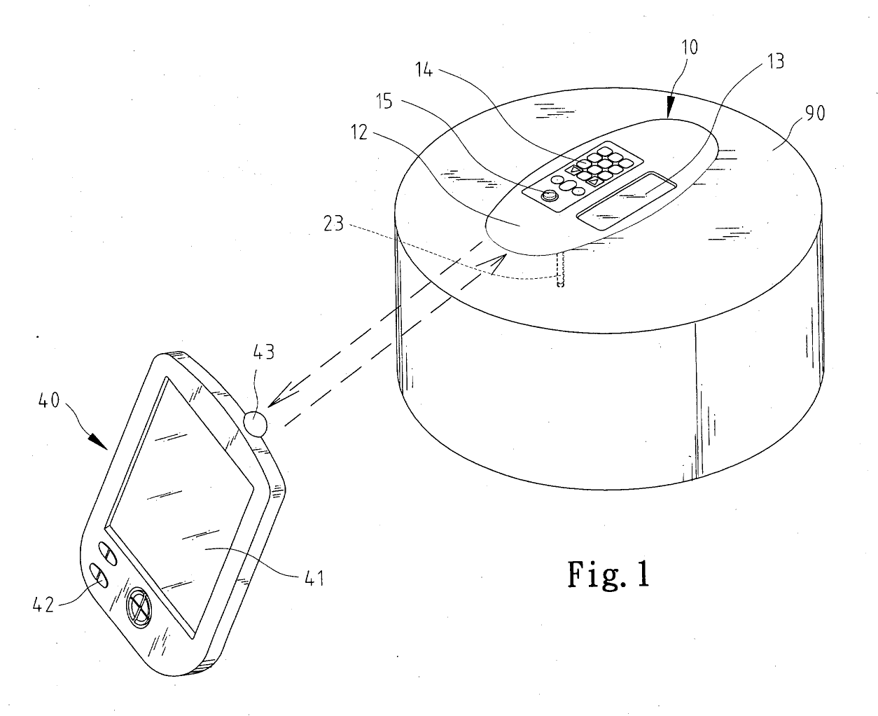

FIG. 1 shows a container 90 equipped with a system for detecting and displaying the status of the container 90 according to a first embodiment of the present invention.

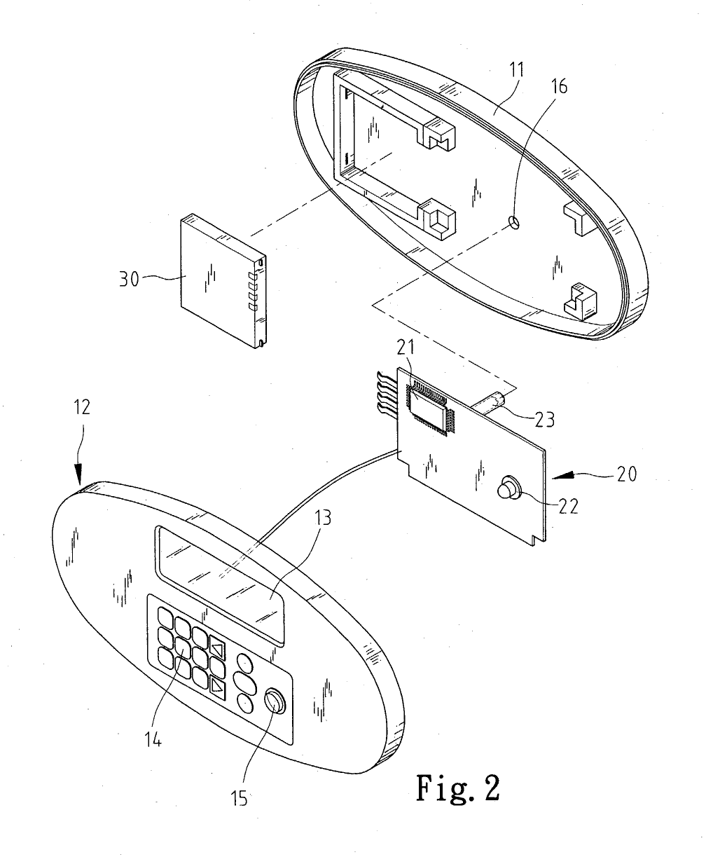

Referring to FIGS. 1 and 2, the recording, detecting and displaying system includes a recording/detecting assembly 10 and a remote displaying assembly 40 in communication of signals with the recording/detecting assembly 10 in a cable-free manner.

The recording/detecting assembly 10 includes a shell (not numbered), a circuit board 20 installed in the shell and a power supply 30 installed in the shell and electrically connected with the circuit board 20.

The shell consists of a pan 11 and a panel 12 mounted on the pan 11. The pan 11 defines a hole 16. The panel 12 includes a display 13 mounted thereon and a keypad 14 mounted thereon.

The circuit board 20 is electrically connected with both of the display 13 and the keypad 14. The circuit board 20 includes a central process unit (“CPU”) 21 installed thereon, a transmitter 22 installed thereon and a probe 23 installed thereon. The circuit board 20 is attached to the pan 11 so that the probe 23 is inserted through the hole 16. When the recording, detecting and displaying system is attached to the container 90, the probe 23 is inserted into the interior of the container 90 through a hole defined in the container 90 for detection of the status of the container 90.

The power supply 30 is attached to the pan 11 and electrically connected with the circuit board 20. Thus, the power supply 30 can power the circuit board 20.

The remote displaying assembly 40 includes a display 41, a plurality of buttons 42 for input of data thereto and a receiver 43 for receiving signals from the transmitter 22 in the cable-free manner.

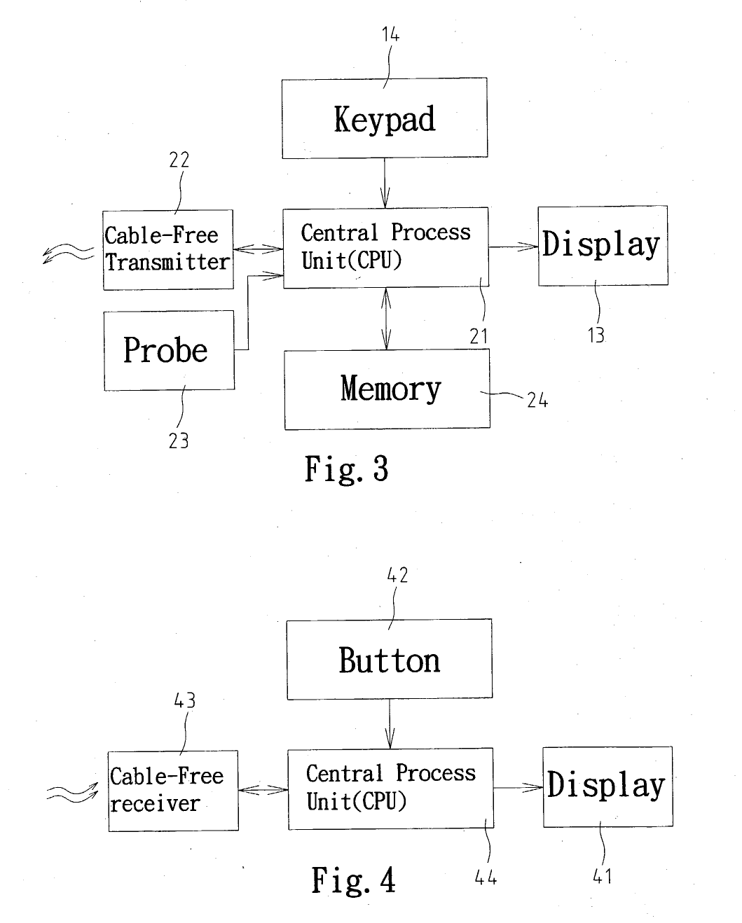

Referring to FIG. 3, a block diagram, the recording/detecting assembly 10 further includes a memory 24 built in the CPU 21 or installed on the circuit board 20.

Data about objects to be or are received in the container 90 such as names and numbers can be entered to the CPU 21 through the keypad 14. The data are processed by means of the CPU 21 and then stored in the memory 24. The probe 23 detects the status of the interior of the container 90 and provides data about the status of the interior of the container 90 to the CPU 21. The CPU 21 processes the data from the probe 23 and then instructs the cable-free transmitter 22 to transmit the signals.

Referring to FIG. 4, a block diagram, the displaying assembly 40 further includes a CPU 44 electrically connected with all of the display 41, buttons 42 and the cable-free receiver 43. The cable-free receiver 43 receives the signals from the transmitter 22 and sends data to the CPU 44. The CPU 44 processes the data from the receiver 43 and then instructs the display 41 to show the data. The remote displaying assembly 40 will not be further described in detail for being conventional.

In this embodiment, the cable-free transmitter 22 is an infrared (“IR”) transmitter for sending IR signals and the cable-free receiver 43 is an IR receiver for receiving the IR signals from the transmitter 22. Since the transmitter 22 is received in the shell, the panel 12 defines a hole through the IR signals are sent. A lens 15 is mounted on the panel 12 in order to cover the hole defined in the panel 12.

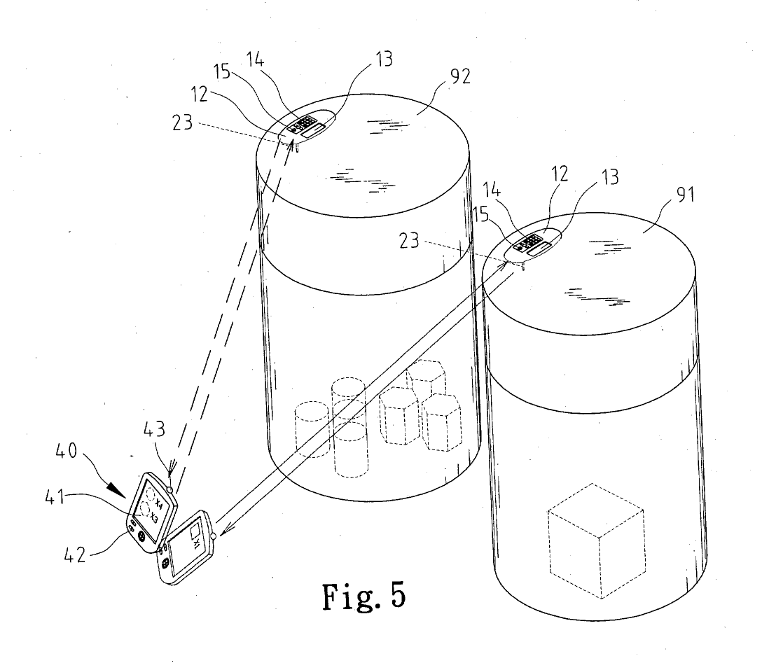

FIG. 5 shows two containers 91 and 92 each equipped with a recording/detecting assembly 10. Each of the detection assemblies 10 is in communication of signals with a remote displaying assembly 40 in the cable-free manner.

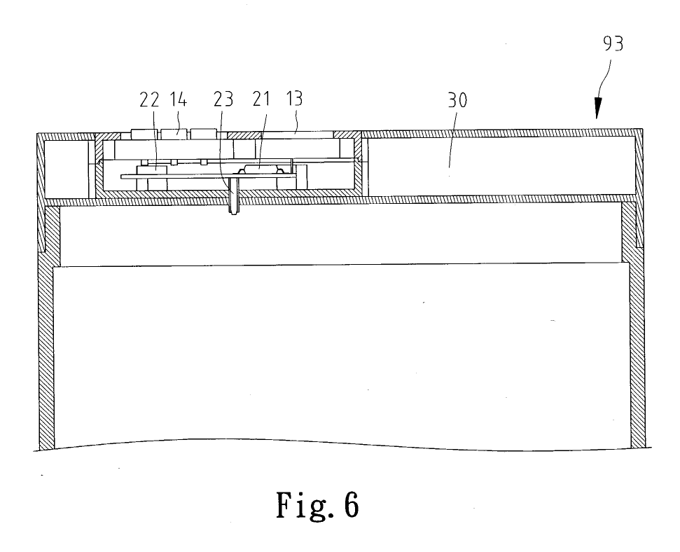

FIG. 6 shows a vacuum container 93 equipped with a recording/detecting assembly 10 according to a second embodiment of the present invention. In the second embodiment, the probe 23 is capable of detecting the pressure in the vacuum container 93. The CPU 21 receives and processes data from the probe 23, and actuates a pump (not shown) to draw air from the vacuum container 93 if necessary. The second embedment is otherwise identical to the first embodiment.

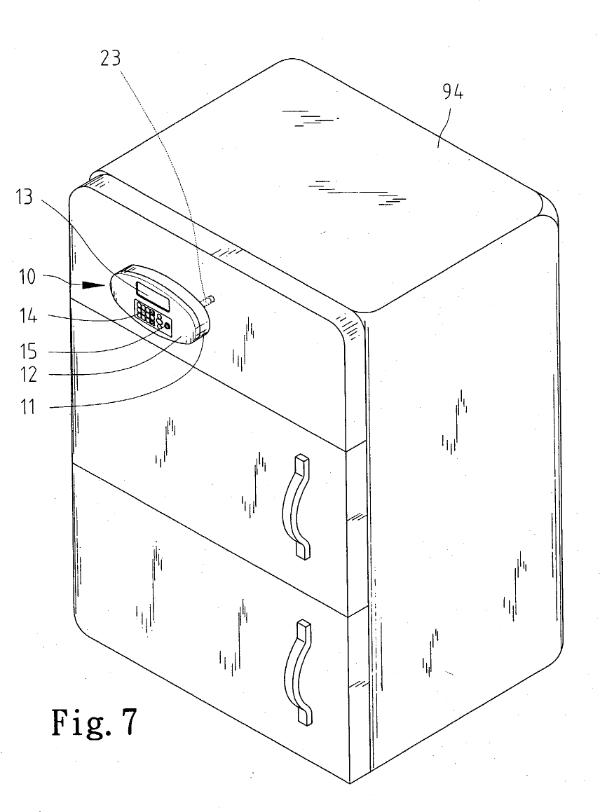

FIG. 7 shows a refrigerator 94 equipped with a recording/detecting assembly 10 according to a third embodiment of the present invention. In the third embodiment, the probe 23 is capable of detecting the temperature in the refrigerator 94. The names and numbers of objects received in the refrigerator 94 are shown on the display 13. A user does not have to open the refrigerator 94 in order to learn the names and numbers of the objects in the refrigerator 94 or search for something that does not exist in the refrigerator 94. Thus, economy of electricity is rendered possible.

The present invention has been described through detailed illustration of several embodiments. Those skilled in the art can derive variations from the illustrated embodiments without departing from the scope of the present invention. Therefore, the illustrated embodiment shall not limit the scope of the present invention defined in the claims.

What is claimed is:

1. A system for recording and displaying the status of a container, the recording and displaying system including:
a recording assembly including a keypad via which data are entered and a transmitter for transmitting the data in a cable-free manner; and
a displaying assembly including a receiver for receiving the data from the transmitter and a display for displaying the data.

2. The recording and displaying system according to claim 1 wherein the recording assembly includes a display on which the data can be displayed.

3. The recording and displaying system according to claim 2 wherein the recording assembly includes a panel on which the display and the keypad are both mounted.

4. The recording and displaying system according to claim 1 wherein the transmitter is an IR transmitter and the receiver is an IR receiver.

5. The recording and displaying system according to claim 1 wherein the recording assembly includes a panel on which the keypad is mounted.

6. The recording and displaying system according to claim 5 wherein the recording assembly includes a circuit board attached to the pan and electrically connected with all of the display, the keypad and the transmitter.

7. The recording and displaying system according to claim 6 wherein the transmitter is installed on the circuit board.

8. The recording and displaying system according to claim 7 wherein the circuit board includes a CPU installed thereon.

9. The recording and displaying system according to claim 8 wherein the circuit board includes a memory installed thereon and electrically connected with the CPU.

10. The recording and displaying system according to claim 8 wherein the CPU includes a memory built therein.

11. A system for detecting and displaying the status of a container, the recording, detecting and displaying system including:
a detecting assembly including a probe extending into the container for detecting a factor of the status of the container and producing data representative of the factor and a transmitter for transmitting the signal in a cable-free manner; and
a displaying assembly including a receiver for receiving the data from the transmitter and a display for displaying the data.

12. The recording and displaying system according to claim 11 wherein the detecting assembly includes a display on which the data can be displayed.

13. The recording and displaying system according to claim 12 wherein the detecting assembly includes a panel on which the display and the keypad are both mounted.

14. The recording and displaying system according to claim 11 wherein the transmitter is an IR transmitter and the receiver is an IR receiver.

15. The recording and displaying system according to claim 11 wherein the detecting assembly includes a panel on which the keypad is mounted.

16. The recording and displaying system according to claim 15 wherein the detecting assembly includes a circuit board attached to the pan and electrically connected with all of the display, the keypad and the transmitter.

17. The recording and displaying system according to claim 16 wherein the transmitter is installed on the circuit board.

18. The recording and displaying system according to claim 17 wherein the circuit board includes a CPU installed thereon.

19. The recording, detecting and displaying system according to claim 18 wherein the circuit board includes a memory installed thereon and electrically connected with the CPU.

20. The recording, detecting and displaying system according to claim 18 wherein the CPU includes a memory built therein.
